(19) United States
(12) Patent Application Publication
(10) Pub. No.: US 2006/0276579 A1
(43) Pub. Date: Dec. 7, 2006

(54) Nanoclay-containing composites and methods of making them

(75) Inventors: David A. Jarus, Avon Lake, OH (US); Guoqiang Qian, Arlington Heights, IL (US); Tie Lan, Arlington Heights, IL (US); Jeff Cicerchi, Avon Lake, OH (US)

Correspondence Address: POLYONE CORPORATION, 33587 WALKER ROAD, AVON LAKE, OH, 44012, US

(73) Assignees: PolyOne Corporation, Avon Lake, OH (US); One North Arlington, Arlington Heights, IL (US)

(21) Appl. No.: 10/595,282

(22) PCT Filed: Oct. 1, 2004
(86) PCT No.: PCT/US04/32650

§ 371 Date: Apr. 4, 2006

Related U.S. Application Data
(60) Provisional application No. 60/509,679, filed on Oct. 8, 2003.
(60) Provisional application No. 60/538,534, filed on Jan. 22, 2004.
(60) Provisional application No. 60/539,250, filed on Jan. 26, 2004.

(51) Int. Cl. C08K 9/04

(52) U.S. Cl. 524/445

(57) ABSTRACT

A composite of nanoclay and thermoplastic matrix polymer is disclosed, optionally containing a polyolefin elastomer and also optionally containing a dispersion agent for the nanoclay. The nanocomposite is prepared for use with thermoplastic polyolefins (TPO's). The polyolefin elastomer, preferably an ethylene-octene copolymer, is added into a mixing extruder downstream of the other ingredients. The nanoconcentrate contributes increased stiffness and toughness to a TPO, which can be used form molded articles such as automotive parts.

### CLAIM OF PRIORITY

This application claims priority from U.S. Provisional Patent Application Serial Numbers:

60/509,679 (bearing Attorney Docket Number 12003023 and filed on Oct. 8, 2003);

60/538,534 (bearing Attorney Docket Number 12004001 and filed on Jan. 22, 2004); and

60/539,250 (bearing Attorney Docket Number 12004002 and filed on Jan. 26, 2004).

### FIELD OF INVENTION

This application relates to polymer mixtures containing nanoclays.

### BACKGROUND OF THE INVENTION

Nanotechnology is an exciting new field of science. The use of intercalated phyllosilicates, also called smectite clays, particularly montmorillonite clays, has been recognized as valuable for reinforcing fillers.

Nanocor, Inc. is a leader in the field of making and selling montmnorillonite nanoclays and concentrates of them where the clays are exfoliated. Further technical and commercial information can be found at www.nanocor.com. U.S. Pat. No. 6,632,868 (Qian et al.) discloses intercalates formed with polypropylene/maleic anhydride-modified polypropylene intercalants.

One of the polymers into which montnorillonite nanoclay is added is a thermoplastic polyolefin (TPO), particularly where the polyolefin is polypropylene (PP).

### SUMMARY OF THE INVENTION

For purposes of this invention, “nanocomposite” means mixture comprising thermoplastic matrix polymer and intercalated nanoclay, whether to be used as a concentrate or as a compound. Optionally, but preferably, the nanocomposite contains a compatibilizing dispersion agent, such as maleated polyolefin. Optionally, but preferably, the nanocomposite contains a polyolefin elastomer to enhance impact resistance.

One aspect of the invention is a nanocomposite having a weight ratio of nanoclay to compatibilizing dispersion agent of less than 2.2:1 and greater than 1:1.9. In this ratio, this nanocomposite is useful as a compound for final article formation via molding or extrusion. Preferably, this nanocomposite has a minimum of 9 weight percent nanoclay dispersed in the nanocomposite compound. More preferably, the nanoclay concentration is 10 or more weight percent. Most preferably, the nanoclay concentration is at least 12 weight percent. At 12 weight percent for nanoclay, the amount of compatibilizing dispersion agent is greater than about 5.5 weight percent and less than 22.8 weight percent.

Another aspect of the invention is a nanocomposite having a weight ratio of nanoclay to compatibilizing dispersion agent of greater than 3.1:1 and less than 10:1. More preferably, the weight ratio is between about 3.5:1 and 5:1. This nanocomposite is useful as a concentrate for later dilution or “let-down” into polymer or as a final compound for extrusion-grade thermoplastic polyolefins.

Another aspect of this invention is a nanocomposite containing a polyolefin elastomer.

Another aspect of the present invention is a method of making nanocomposite wherein the polyolefin elastomer is added downstream in an extruder from where the other ingredients are added.

Another aspect of the present invention is a method of making nanocomposite compound wherein the thermoplastic matrix polymer, nanoclay, compatibilizing dispersion agent, and optional additives are added as individual ingredients at the inlet of an extruder, followed by addition of polyolefin elastomer (for impact modification) at a downstream port of the extruder. In this manner the TPO is made from all raw materials, not a concentrate of either TPO or nanocomposite.

An advantage of the present invention is that a balance of stiffness and toughness is achieved using in a TPO using the nanocomposites of the present invention prepared according to the method of the present invention. This balance of stiffness and toughness is superior to those of the TPO without nanoclays therein.

Another advantage of the present invention is that the method delays addition of the optional polyolefin elastomer until after the nanoclay is thoroughly dispersed in the matrix polymer, usually PP. The optional compatibilizing dispersion agent, especially maleated polyolefin, enhances thorough dispersion of the nanoclay in the matrix polymer before any interaction of optional polyolefin elastomer can occur. This delay, it is believed, assures that the nanoclay present is not as likely to become intermixed within the dispersed phase of polyolefin elastomer. Thus, the valuable nanoclay can increase the benefit of its properties in the final article molded from a combination of TPO and the nanocomposite of the present invention.

### EMBODIMENTS OF THE INVENTION

TPO's are commercially available from such multi-national sources as Basell Polyolefins. TPO's can have a variety of properties, ranging from rigid to flexible to impact-modified polyolefin copolymers along a continuum known to those skilled in the art. The final use of an article made from TPO benefits from these tailored properties.

The thermoplastic matrix polymer for the present invention can be any thermoplastic suitable for molding or extruding operations where lightness, stiffness, and toughness are desired as performance properties. Non-limiting examples of such polymers are polyolefins, polyamides, polyesters, polyurethanes, styrenic polymers, polycarbonates, polyvinyl halides, and combinations thereof.

Nanoclay is a clay from the smectite family. Smectites have a unique morphology, featuring one dimension in the nanometer range. Montmorillonite clay is the most common member of the smectite clay family. The montmorillonite clay particle is often called a platelet, meaning a sheet-like structure where the dimensions in two directions far exceed the particle's thickness.

Nanoclay becomes commercially significant if intercalated with an intercalant. An intercalate is a clay-chemical complex wherein the clay gallery spacing has increased, due to the process of surface modification by an intercalant. Under the proper conditions of temperature and shear, an intercalate is capable of exfoliating in a resin matrix. An intercalant is an organic or semi-organic chemical capable of entering the montmorillonite clay gallery and bonding to the surface. Exfoliation describes a dispersion of a surface treated nanoclay in a plastic matrix.

In exfoliated form, nanoclay platelets have a flexible sheet-type structure which is remarkable for its very small size, especially the thickness of the sheet. The length and breadth of the particles range from 1.5 μm down to a few tenths of a micrometer. However, the thickness is astoundingly small, measuring only about a nanometer (a billionth of a meter). These dimensions result in extremely high average aspect ratios (75-500). Moreover, the miniscule size and thickness mean that a single gram contains over a million individual particles.

As defined above, nanocomposites are the combination of the surface treated nanoclay and the plastic matrix. In polymer compounding, a nanocomposite concentrate is a very convenient means of delivery of the nanoclay into the ultimate compound, provided that the plastic matrix of the nanocomposite concentrate is compatible with the principal polymer resin components of the compounds. In such manner, nanocomposites are available in concentrates, masterbatches, and compounds from Nanocor, Inc. of Arlington Heights, Ill. (www.nanocor.com) and PolyOne Corporation of Avon Lake, Ohio (www.polyone.com) in a variety of nanocomposites.

Nanocomposites offer flame-retardancy properties because such nanocomposite formulations burn at a noticeably reduced burning rate and a hard char forms on the surface. They also exhibit minimum dripping and fire sparkling.

When using Nanocor produced nanoclay, the amount of this additive in concentrate form can range from about 2 weight percent to about 50 weight percent, and preferably between about 3 and about 40 weight percent of the total compound. Upon addition to the compound, the intercalated nanoclay exfoliates with the addition of compatibilizers known to those skilled in the art. In a preferred embodiment, the compatibilizer is a grafted maleic anhydride such as disclosed in U.S. Pat. No. 5,717,500 (Karande et al.). The use of compatibilizer is also disclosed in U.S. Pat. No. 6,632,868 (Qian et al.). However the use of “nanocomposite” as defined herein supercedes any inconsistent connotation of that word in Qian et al.

The preparation of nanocomposites uses extrusion mixing equipment known to those skilled in the art, such as disclosed in Qian et al. But the present invention departs from convention. Conventionally, a concentrate is made by mixing TPO and nanoclay, and optionally a compatibilizing dispersion agent such as maleated polypropylene (PP-g-MAH).

In the present invention, the TPO is not used in forming the concentrate. Rather, the constituents of the TPO, (i.e., PP and an elastomer, particularly a polyolefin elastomer), are added separately and at different locations in the extruder. More specifically, the polyolefin elastomer is added downstream of the other ingredients, which gives the nanoclay and its optional dispersion agent both more time and less interference in dispersing completely within the polypropylene carrier. This method of the present invention is useful for making both nanocomposite concentrates and nanocomposite compounds of any weight ratio, including those disclosed in Qian et al.

Preferably, the method of the present invention can be used for concentrates and extrusion-grade compounds where the weight ratio of nanoclay to compatibilizing dispersion agent is greater than 3.1:1 and less than 10:1. Preferably, the weight ratio is a range of about 3.1:1 to 5:1.

Also preferably, the method of the present invention can be used for compounds where the weight ratio of nanoclay to compatibilizing dispersion agent of less than 2.2:1 and greater than 1:1.9. Preferably, the weight ratio can be about 1.5:1 to 1:1 and more preferably about 1.33:1 in order to improve both dispersion of nanoclay in the compound (before optional polyolefin elastomer addition downstream of the extruder inlet) and increase the lightness and stiffness of the compound by maximizing the amount of nanoclay that can be dispersed into the compound.

Preferably, the mixing equipment is a co-rotating twin-screw extruder commercially available from Werner-Pfeiderer. The extruder should be capable of screw speeds ranging from about 50 to about 2,000 rpm. The temperature profile from the barrel number two to the die should range from the melting temperature of the thermoplastic matrix polymer to about 270° C., and preferably from around 200° C. for this nanoconcentrate. The nanocomposite can be pelletized for later use.

If the weight ratio of nanoclay to compatibilizing dispersion agent is greater than 3.1:1 and less than 10:1, then the pellets are suitable for use as concentrates for dilution or “let-down” in later molding operations to make a final article. Preferably, the concentrate pellets can be added at the inlet of the final molding equipment. Alternatively, the pellets can be used as a compound for certain extruded articles, without further dilution. It has been found unexpectedly that the final balance of mechanical properties desired for the final article can be achieved with a ratio of nanoclay to compatibilizing dispersion agent that minimizes use of that latter material. Thus, the weight ratio is within the range of a nanocomposite concentrate but can be used as a nanocomposite compound, according to the present invention. If the weight ratio of nanoclay to compatibilizing dispersion agent of less than 2.2:1 and greater than 1:1.9, then the pellets are suitable for use as a final compound for molding or extrusion into a final article.

Polyolefin elastomers or rubber in the present invention optionally are used for the separate mixing reason described above, instead of an already blended TPO. Any suitable polyolefin elastomer can be used. For example, polybutadiene rubber, ethylene-propylene-diene rubber (EPDM), ethylene-octene copolymers, and other elastomers are useful. Non-limiting examples of such elastomers are those commercially available from multinational companies such as Bayer, Dupont-Dow Elastomers, Uniroyal Chemical, ExxonMobil, and others. ENGAGE™ 8180, ENGAGE™ 8842, and other ENGAGE™ polyolefin elastomers are especially preferred ethylene-octene copolymers available from DuPont Dow Elastomers LLC of Wilmington, Del. that function well as impact modifiers for nanocomposites of the invention.

Nanocomposite concentrate pellets of the present invention can be mixed with TPO's to form articles benefiting from a balance of stiffness and toughness properties introduced by the nanoclays therein. The nanocomposite concentrate can be diluted or “let-down” in any ratio that one skilled in the art desires to yield as a final nanoclay concentration in the article.

One way of dilution is with a twin-screw extruder from any number of sources or a continuous mixer from Farrel. Further information on this technique is found at www.nanocor.com/tech sheets/P806.pdf which describes let-down of conventional nanoconcentrates into TPO's.

Another way of dilution is mixing the nanocomposite concentrate pellets at the point of molding the final article. The mixing inlet for any type of molding machine can be sufficient to disperse the concentrate of the present invention into the TPO. This is an efficient way to introduce a more expensive concentrate into a final molded product, based on working capital requirements of raw material inventory, because the concentrate arrives just-in-time.

A TPO compounder that does not need to use a concentrate additive for TPO production can add all of the raw materials, except for polyolefin elastomer, at the inlet throat of the extruder. The polyolefin elastomer, to modify impact and add toughness to the compound, is added at a downstream port after the nanoclay and compatibilizing dispersion agent have fully intermixed and dispersed into the thermoplastic polyolefin matrix polymer. In this fashion, if the compounder delays the conventional addition of polyolefin elastomer to a mid-extruder location and mixes nanoclay and compatibilizing dispersion agent to the inlet throat of the extruder, that compounder can have all of the processing and performance benefits of a TPO with the added lightness and stiffness provided by the nanoclay therein.

Other Optional Ingredients

Those skilled in the art of compounding TPO's recognize the desire to add optional ingredients to the nanocomposites of the present invention. Such optional ingredients include colorants (dyes or pigments), nucleators, blowing agents, activators which lower the activation temperature of the blowing agent, surfactants, plasticizers, stabilizers, flame retardants, UV absorbers, fillers, fragrances, mold release aids, processing aids, biocides, antistatic additives, anti-microbial agents, lubricants, and combinations of them. The optional additives should be added in an effective but not wasteful amount according to the particular processing or performance purposes of such additives in the nanocomposites of the present invention. Without undue experimentation, one skilled in the art can determine the minimum effective amount and the maximum non-wasteful amount for each desired additive.

Usefulness of the Invention

Final molded articles made from TPO are more valuable because nanoclays provide increased lightness and stiffness while retaining toughness. Such molded articles can be made into any number of shapes, among them, automobile parts, large appliance parts, and the like. Further explanation of the invention is found in the following examples.

### EXAMPLES

### Examples 1-17 and Comparative Examples A-C

Nanoclay-containing composites were prepared according to the recipes and commercial sources stated in Table 1 and the mixing conditions stated in Table 2. The concentration of nanoclay and dispersion agent were kept constant with the concentration of polyolefin copolymer rubber being varied.

TABLE 1
Concentrate Recipes for Use in TPO

Ingredient Wt %

| | 1 | 2 | 3 | 4 |
|---|---|---|---|---|
| Nanoclay | 40 | 40 | 40 | 40 |
| PP-g-MAH | 10 | 10 | 10 | 10 |
| EO Copolymer Rubber | 15 | 10 | 5 | 0 |
| PP | 35 | 40 | 45 | 50 |

Commercial Sources

| Ingredient and Use | Source | Brand(s) |
|---|---|---|
| Nanoclay to enhance stiffness | Nanocor | I44P |
| Ethylene-Octene Copolymer | DuPont-Dow | EG8180 |
| to modify impact | | |
| PP-g-MAH (maleated | Crompton | PolyBond PBX5104 |
| polypropylene) to disperse | | |
| nanoclay | | |
| PP (polypropylene) to | | |
| serve as concentrate carrier | | |
| TPO (thermoplastic polyolefin) | Basell | CA387; Adflex |
| | | KS311P; and |
| | | Pro-Fax SG702 |

The weight ratio of nanoclay to compatibilizing dispersion agent is 4:1, suitable for use as a nanocomposite concentrate.

TABLE 2
Concentrate Making Conditions

| Example | | | |
|---|---|---|---|
| 1 | 2 | 3 | 4 |

| | |
|---|---|
| Concentrate Mixing | Werner & Pfleiderer ZSK 25 co-rotating |
| Equipment | twin screw extruder |
| Concentrate Mixing | 200° C. |
| Temperature | |
| Concentrate Mixing | 1100 rpm |
| Speed | |
| Order of Addition | All Ingredients except Ethylene-Octene |
| | Copolymer are added together, with EO |
| | Copolymer added downstream, i.e., after |
| | thorough dispersion of nanoclay and |
| | dispersion agent in carrier |

After the concentrates 1-4 were made, they were mixed into three different TPO's to simulate the addition of a nanocomposite concentrate just prior to molding of the TPO into a useful article.

Table 3 shows the amount of dilution, also known as let-down, along with the test results for stiffness and toughness of the final article.

TABLE 3
TPO Compounds

| | | Wt. | | Wt. |
|---|---|---|---|---|
| Example | Concentrate | Percent | TPO | Percent |
| Comp. A | — | — | CA387P | 100% |
| 5 | 1 | 20% | CA387P | 80% |
| 6 | 2 | 20% | CA387P | 80% |
| 7 | 3 | 20% | CA387P | 80% |
| 8 | 4 | 20% | CA387P | 80% |
| Comp. B | — | — | Pro-Fax SG702 | 100% |
| 9 | 1 | 20% | Pro-Fax SG702 | 80% |
| 10 | 2 | 20% | Pro-Fax SG702 | 80% |
| 11 | 3 | 20% | Pro-Fax SG702 | 80% |
| 12 | 4 | 20% | Pro-Fax SG702 | 80% |
| Comp. C | — | — | Adflex KS311P | 100% |
| 13 | 1 | 20% | Adflex KS311P | 80% |
| 14 | 2 | 20% | Adflex KS311P | 80% |
| 15 | 3 | 20% | Adflex KS311P | 80% |
| 16 | 4 | 20% | Adflex KS311P | 80% |
| 17 | 2 | 10% | Adflex KS311P | 90% |

| | | | ASTM D3837 (Joules) | | | | | |
|---|---|---|---|---|---|---|---|---|
| | ASTM D790 (PSI) | | Inst. Impact Room Temp. | | Inst. Impact 0° C. | | Inst. Impact −30° C. | |
| Example | Flex. Mod. | Stress at Yield | Peak | Total | Peak | Total | Peak | Total |
| Comp. A | 120000 | 3380 | 16.7 | 30.7 | | | 24.9 | 45 |
| 5 | 149000 | 3540 | 16.8 | 30.5 | | | 24.6 | 39.3 |
| 6 | 157000 | 3740 | 16.6 | 30.2 | | | 22.6 | 27 |
| 7 | 158000 | 3850 | 16.6 | 29.7 | | | 13.8 | 14.4 |
| 8 | 179000 | 4110 | 16.5 | 28.7 | | | 3.9 | 4.9 |
| Comp. B | 155000 | 4770 | 18.8 | 33.8 | 22.4 | 41.3 | | |
| 9 | 233000 | 5530 | 20.1 | 31.1 | 24.1 | 37.4 | | |
| 10 | 239000 | 5650 | 21.1 | 30.3 | 18.5 | 22.5 | | |
| 11 | 244000 | 5720 | 20.6 | 28.5 | | | | |
| 12 | 258000 | 5980 | 20.6 | 24.3 | 11.5 | 12.1 | | |
| Comp. C | 78400 | 2530 | 13.8 | 25 | | | | |
| 13 | 123000 | 3040 | 16.1 | 26.9 | | | | |
| 14 | 130000 | 3220 | 15.7 | 26.4 | | | | |
| 15 | 133000 | 3330 | 15.1 | 26.2 | | | | |
| 16 | 149000 | 3540 | 15.4 | 25.4 | | | | |
| 17 | 109000 | 3010 | 15.2 | 26.4 | | | | |

Table 3 shows that Examples 5-8, 9-12, and 13-16 (each containing 8 wt. percent nanoclay) consistently outperform the Comparative Examples A, B, and C, respectively, in respect of Flexural Modulus and Stress at Yield. Because each of the Comparative Examples are different types of TPO (A is a rigid TPO; B is an impact copolymer; and C is a flexible TPO), assessment of instrument impact performance is more complex. All of Examples 5-16 exhibit ductility by comparing the peak vs. total instrument impact values. As polyolefin copolymer content decreases, instrument impact performance at the various operational temperatures also decreases. Therefore, the balance of stiffness and toughness is found preferably in Examples 5, 9, and 13.

Examples 14 and 17 compare the amount of nanoclay present in the TPO compounds of the same ingredients, with Example 14 containing 8% nanoclay and Example 17 containing 4%. Along with Comparative Example C, a trend line can be established from 0 to 4 to 8 weight percent, with increased stiffness along that line.

### Examples 18-34 and Comparative Examples D-F

A second set of experiments was conducted to further elucidate the scope of the present invention in the ability to make a final compound directly by introducing the various ingredients as raw materials directly into the extruder. Table 4 shows the ingredients and their commercial sources. Table 5 shows the 7 different recipes (A-G) based on three different formulations and variations of mixing in the extruder. Table 6 shows the results of 20 different extrusions and resulting properties (Examples 18-34 and Comparative Examples D-F). The weight ratio of nanoclay to compatibilizing dispersion agent for all Examples is 12:9 or 1.33:1.

TABLE 4
Commercial Sources

| Ingredient and Use | Source | Brand(s) |
|---|---|---|
| Nanoclay to enhance stiffness | Nanocor | I44P |
| Ethylene-Octene Copolymer to | DuPont-Dow | EG8180 |
| modify impact | | |
| PP-g-MAH (maleated polypropylene) | Crompton | PolyBond PBX5104 |
| to disperse nanoclay | | |
| Polypropylene (12 Melt Flow Index) | Basell | Pro-Fax 6323 |
| Blend of Irganox 1010 and Irgafos | Ciba | B-225 |
| 168 Processing Stabilizers | | |
| PP (60 Melt Flow Index) | Various | PP 60MFI |

TABLE 5

| | |
|---|---|
| Mixing Equipment | Werner & Pfleiderer ZSK 25 co- rotating twin screw extruder |
| Mixing Temperature | 200° C. |

Recipes and Order of Addition

| | | | | | | | | | | Recipe F | | | |
|---|---|---|---|---|---|---|---|---|---|---|---|---|---|
| Recipe A | | Recipe B | | Recipe C | | Recipe D | | Recipe E | | (Comparative) | | Recipe G | |
| | Wt. | | Wt. | | Wt. | | Wt. | | Wt. | | Wt. | | Wt. |
| Ingredient | % | Ingredient | % | Ingredient | % | Ingredient | % | Ingredient | % | Ingredient | % | Ingredient | % |

Feeder 1 at Throat

| | | | | | | | | | | | | | |
|---|---|---|---|---|---|---|---|---|---|---|---|---|---|
| I.44P | 12 | I.44P | 12 | I.44P | 12 | I.44P | 12 | I.44P | 12 | I.44P | 12 | I.44P | 12 |
| Nanomer | | Nanomer | | Nanomer | | Nanomer | | Nanomer | | Nanomer | | Nanomer | |

Feeder 2 at Throat

| | | | | | | | | | | | | | |
|---|---|---|---|---|---|---|---|---|---|---|---|---|---|
| B-225 | 0.3 | B-225 | 0.3 | B-225 | 0.3 | B-225 | 0.3 | B-225 | 0.3 | B-225 | 0.3 | B-225 | 0.3 |
| PB X5104 | 9 | PB X5104 | 9 | PB X5104 | 9 | PB X5104 | 9 | PB X5104 | 9 | PB X5104 | 9 | PB X5104 | 9 |
| Profax | 18.7 | Profax | 9.35 | Profax | 0 | Profax 6323 | 38.7 | Profax | 20 | Profax | 58.7 | Profax 6323 | 8.7 |
| 6323 | | 6323 | | 6323 | | | | 6323 | | 6323 | | | |
| PP 60MFI | 0 | PP 60MFI | 9.35 | PP 60MFI | 18.7 | PP 60MFI | 0 | PP 60MFI | 18.7 | Engage | 20 | PP 60MFI | 0 |
| | | | | | | | | | | 8180 | | | |

Feeder 3 at Side Port Downstream

| | | | | | | | | | | | |
|---|---|---|---|---|---|---|---|---|---|---|---|
| Engage | 20 | Engage | 20 | Engage | 20 | Engage | 20 | Engage | 20 | Engage | 20 |
| 8180 | | 8180 | | 8180 | | 8180 | | 8180 | | 8180 | |
| Profax | 40 | Profax | 40 | Profax | 40 | Profax 6323 | 20 | Profax | 20 | Profax 6323 | 50 |
| 6323 | | 6323 | | 6323 | | | | 6323 | | | |

TABLE 6

| | | | | | | | | | | | | | Notched Izod | | |
|---|---|---|---|---|---|---|---|---|---|---|---|---|---|---|---|
| | | Addition Parameters | | | Flexural Modulus | | Modulus | | Stress | | % Elongation | | (±Std. Dev.) | | |
| | | | Mix | Feed | (±Std. Dev.) | | (±Std. Dev.) | | (±Std. Dev.) | | (±Std. Dev.) | | with Break, if any. | | |
| | | | Speed | Rate | ASTM D790 | | ASTM D638 | | ASTM D638 | | ASTM D638 | | ASTM D256 | | |
| Example | Recipe | Ratio* | (rpm) | (Lbs/hr) | (psi*1000) | | (psi*1000) | | (psi) | | (in/in) | | (ft-lb/in) | | |
| 18 | A | 40/60 | 500 | 40 | 302 | ±10 | 388 | ±21 | 4600 | ±200 | 7.2 | ±0.2 | 5.3 | ±0.5 | Partial |
| 19 | A | 40/60 | 1000 | 40 | 266 | ±2 | 355 | ±3 | 4330 | ±12 | 9.0 | ±0.1 | 10.3 | ±0.2 | Partial |
| 20 | A | 40/60 | 1000 | 80 | 263 | ±8 | 349 | ±5 | 4170 | ±22 | 7.8 | ±0.1 | 6.3 | ±0.5 | Partial |
| 21 | A | 40/60 | 500 | 80 | 228 | ±1 | 304 | ±5 | 3610 | ±29 | 7.3 | ±0.1 | 3.7 | ±0.2 | Partial |
| 22 | B | 40/60 | 500 | 80 | 272 | ±1 | 360 | ±7 | 4250 | ±8 | 8.3 | ±0.1 | 8.3 | ±0.4 | Partial |
| 23 | B | 40/60 | 1000 | 80 | 255 | ±4 | 347 | ±16 | 3890 | ±29 | 8.0 | ±0.3 | 6.9 | ±0.4 | Partial |
| 24 | B | 40/60 | 1000 | 40 | 232 | ±3 | 335 | ±12 | 4080 | ±2 | 8.1 | ±0.1 | 2.2 | ±0.2 | Partial |
| 25 | B | 40/60 | 500 | 40 | 254 | ±1 | 306 | ±7 | 3690 | ±6 | 7.8 | ±0.1 | 5.8 | ±0.1 | Partial |
| 26 | C | 40/60 | 1000 | 40 | 246 | ±2 | 344 | ±5 | 3870 | ±45 | 9.0 | ±0.3 | 12.0 | ±0.9 | Non-break |
| 27 | C | 40/60 | 500 | 80 | 231 | ±2 | 309 | ±12 | 3480 | ±61 | 7.2 | ±0.1 | 6.7 | ±0.4 | Partial |
| 28 | D | 60/40 | 500 | 40 | 280 | ±4 | 366 | ±12 | 4480 | ±30 | 7.8 | ±0.1 | 5.9 | ±0.4 | Partial |
| 29 | D | 60/40 | 1000 | 40 | 266 | ±4 | 346 | ±5 | 4300 | ±6 | 8.9 | ±0.1 | 6.9 | ±0.2 | Partial |
| 30 | D | 60/40 | 1000 | 80 | 241 | ±1 | 319 | ±7 | 3870 | ±15 | 8.3 | ±0.2 | 6.1 | ±0.3 | Partial |
| 31 | D | 60/40 | 500 | 80 | 222 | ±2 | 284 | ±6 | 3480 | ±7 | 7.8 | ±0.1 | 4.3 | ±0.3 | Partial |
| 32 | E | 60/40 | 1000 | 80 | 289 | ±3 | 378 | ±8 | 4480 | ±19 | 6.7 | ±0.1 | 4.5 | ±0.3 | Partial |
| 33 | E | 60/40 | 1000 | 40 | 257 | ±1 | 332 | ±5 | 3970 | ±9 | 7.8 | ±0.1 | 6.6 | ±0.3 | Partial |
| Comp. D | F | 100/0 | 500 | 40 | 292 | ±2 | 383 | ±8 | 4500 | ±5 | 7.8 | ±0.2 | 7.0 | ±0.5 | Partial |
| Comp. E | F | 100/0 | 1000 | 40 | 243 | ±2 | 321 | ±9 | 3810 | ±13 | 9.6 | ±0.1 | 7.5 | ±0.4 | Partial |
| Comp. F | F | 100/0 | 1000 | 80 | 237 | ±1 | 313 | ±3 | 3720 | ±13 | 9.4 | ±0.2 | 6.7 | ±0.3 | Partial |
| 34 | G | 30/70 | 1000 | 80 | 298 | ±1 | 390 | ±10 | 4470 | ±20 | 7.6 | ±0.1 | 7.2 | ±0.4 | Partial |

*Ratio of Addition of Ingredients at Throat vs. Downstream

Table 6 shows that addition of polyolefin elastomer at the side port downstream permits thorough dispersion of nanoclay, polypropylene, and maleated polypropylene in the extruder, such that an excellent performing TPO is made into pellets for subsequent molding or extrusion. The flexural modulus of the TPO is at least 222,000 lbs/in². A direct comparison (Comparative Example D with Examples 18 and 28), (Comparative Example E with Examples 19 and 29), and (Comparative Example F with Examples 20, 30, and 34) shows higher flexural modulus with delayed addition of elastomer and delayed addition of a portion of the thermoplastic matrix polymer to improve ability to disperse nanoclay in the upstream section of the extruder.

### Example 35

This example shows a 4:1 weight ratio of nanoclay to compatibilizing dispersion agent that has performance properties that do not require further dilution for extrusion-grade thermoplastic polyolefins. Table 7 shows the formulation. Table 8 shows the mechanical properties of the compound.

TABLE 7
Example 35 Formulation

| Ingredient and Use | Wt. Percent | Brand(s) | Source |
|---|---|---|---|
| Nanoclay to enhance stiffness | 12 | I44P | Nanocor |
| Polypropylene copolymer | 84.2 | Inspire 114 | Dow |
| PP-g-MAH (maleated | 3 | PolyBond | Crompton |
| polypropylene) to | | PBX5104 | |
| disperse nanoclay | | | |
| Di-stearyl-thio-diproprionate | 0.5 | DSTDP | Various |
| Blend of Irganox 1010 and | 0.3 | B-225 | Ciba |
| Irgafos 168 Processing | | | |
| Stabilizers | | | |

TABLE 8

Addition Parameters

| | Ratio | 40/60 |
|---|---|---|
| | Mix Speed (rpm) | 1000 |
| | Feed Rate (Lbs/hr) | 80 |
| Flexural Modulus | ASTM D790 (psi*1000) | 323 ± 1 |
| (±Std. Dev.) | | |
| Modulus | ASTM D638 (psi*1000) | 401 ± 7 |
| (±Std. Dev.) | | |
| Stress | ASTM D638 (psi) | 4790 ± 14 |
| (±Std. Dev.) | | |
| % Elongation | ASTM D638 (in/in) | 8.4 ± 0.2 |
| (±Std. Dev.) | | |
| Notched Izod | ASTM D256 (ft-lb/in) | 5.9 ± 0.3 |
| (±Std. Dev.) | | Partial Break |
| with Break, if any | | |

The invention is not limited to the above embodiments. The claims follow.

What is claimed is:

1. A compound, comprising:
a nanocomposite selected from the group consisting of
(a) thermoplastic matrix polymer, nanoclay, and compatibilizing dispersion agent having a weight ratio of nanoclay to compatibilizing dispersion agent of less than 2.2:1 and greater than 1:1.97 and
(b) thermoplastic matrix polymer, nanoclay, and compatibilizing dispersion agent having a weight ratio of nanoclay to compatibilizing dispersion agent of greater than 3.1:1 and less than 10:1.

2. The compound of claim 1, wherein the nanocomposite further comprises a polyolefin elastomer.

3. The compound of claim 1, wherein the nanocomposite further comprising ingredients selected from the group consisting of colorants, nucleators, blowing agents, activators which lower the activation temperature of the blowing agent, surfactants, plasticizers, stabilizers, flame retardants, UV absorbers, fillers, fragrances, mold release aids, processing aids, biocides, antistatic additives, anti-microbial agents, lubricants, and combinations of them.

4. The compound of claim 1, wherein the nanoclay comprises at least 9 weight percent of the nanocomposite.

5. The compound of claim 1, wherein the compound further comprises a thermoplastic polyolefin mixed with the nanocomposite.

6. The compound of claim 1 in the form of an article.

7. The compound of claim 5, wherein the nanocomposite is mixed with a thermoplastic polyolefin at a point of molding or extruding a final thermoplastic article.

8. The compound of claim 7, wherein the thermoplastic polyolefin and the nanocomposite are mixed at a ratio of about 4:1 of thermoplastic polyolefin to nanocomposite.

9. The compound of claim 4, wherein the nanocomposite is in the form of pellets for further processing.

10. The compound of claim 4, wherein the nanocomposite is in the form of a molded or extruded article.

11. A method of making a compound of claim 2, comprising the steps of
(a) adding the thermoplastic matrix polymer, nanoclay, and nanoclay dispersion agent to an extruder; and
(b) adding the polyolefin elastomer downstream from where the thermoplastic matrix polymer, nanoclay, and nanoclay dispersion agent were added.

12. The method of claim 11, wherein step (a) also includes adding ingredients selected from the group consisting of colorants, nucleators, blowing agents, activators which lower the activation temperature of the blowing agent, surfactants, plasticizers, stabilizers, flame retardants, UV absorbers, fillers, fragrances, mold release aids, processing aids, biocides, antistatic additives, anti-microbial agents, lubricants, and combinations of them.

13. The compound of claim 2, wherein the nanocomposite further comprising ingredients selected from the group consisting of colorants, nucleators, blowing agents, activators which lower the activation temperature of the blowing agent, surfactants, plasticizers, stabilizers, flame retardants, UV absorbers, fillers, fragrances, mold release aids, processing aids, biocides, antistatic additives, anti-microbial agents, lubricants, and combinations of them.

14. The compound of claim 2, wherein the nanoclay comprises at least 9 weight percent of the nanocomposite.

15. The compound of claim 2, wherein the compound further comprises a thermoplastic polyolefin mixed with the nanocomposite.

16. The compound of claim 3, wherein the nanoclay comprises at least 9 weight percent of the nanocomposite.

17. The compound of claim 3, wherein the compound further comprises a thermoplastic polyolefin mixed with the nanocomposite.

18. The compound of claim 2 in the form of an article.

19. The compound of claim 3 in the form of an article.

20. The compound of claim 4 in the form of an article.
